(19) United States
(12) Patent Application Publication
(10) Pub. No.: US 2026/0148367 A1
(43) Pub. Date: May 28, 2026

(54) METHOD FOR INSPECTING CELL ELECTRODE AND APPARATUS THEREOF

(71) Applicant: SK ON CO., LTD., Seoul (KR)

(72) Inventor: Dong Whan SHIN, Daejeon (KR)

(21) Appl. No.: 19/396,344

(22) Filed: Nov. 21, 2025

(30) Foreign Application Priority Data
Nov. 22, 2024 (KR) 10-2024-0168529

(51) Int. Cl. G06T 7/00; G06T 7/33; G06T 7/73; G06T 12/00

(52) U.S. Cl. CPC G06T 7/0006; G06T 7/337; G06T 7/344; G06T 7/75; G06T 12/00; G06T 2207/10048; G06T 2207/20081; G06T 2207/30164

(57) ABSTRACT

A method for inspecting a cell electrode and an apparatus thereof may be provided, wherein the apparatus for inspecting a cell electrode comprises a first imager configured to acquire an electrode image, a second imager configured to acquire a separator image, an image processor configured to align the acquired electrode image and the acquired separator image, and composite the electrode image and the separator image to generate a cell electrode image, an inspector configured to determine whether the cell electrode is defective using the composited cell electrode image and a controller configured to control the first imager, the second imager, the image processor, and the inspector.

### CROSS-REFERENCE TO RELATED APPLICATION

This application claims priority to Korean Patent Application No. 10-2024-0168529 filed November 22, 2024, the disclosure of which is hereby incorporated by reference in its entirety.

### BACKGROUND

### Technical Field

The present disclosure relates to a method for inspecting a cell electrode and an apparatus thereof.

### Technical Considerations

Current battery technology is used in various application fields such as smartphones, electric vehicles, and energy storage systems (ESS), and its performance and stability largely depend on the structure and state of electrodes and separators inside a battery cell.

The separator, located between a positive electrode (cathode) and a negative electrode (anode) inside the battery cell, insulates the electrodes and ensures safe and efficient energy storage. However, if the arrangement or spacing of the electrodes and the separator is defective, a short circuit phenomenon between the electrodes may occur.

Therefore, accurately identifying the state of such electrodes and separators and determining whether they are defective is essential to ensure the stability and performance of the battery.

Conventionally, radiation-based imaging technologies such as X-ray CT, which can only capture the internal electrode structure of a battery cell, have been utilized. However, these technologies have limitations in identifying the precise relative position of the electrodes with respect to the separator. Furthermore, there is a limitation in acquiring an image of a thin and highly transparent material, such as a separator, using X-ray imaging.

Additionally, there have been difficulties in three-dimensionally analyzing the alignment state or overlapping state of the electrodes and the separator, posing a limitation on overall quality inspection.

### SUMMARY

Embodiments of the present disclosure may provide a method for inspecting a cell electrode and an apparatus thereof, capable of simultaneously inspecting an electrode and a separator.

The method for inspecting a cell electrode and the apparatus thereof according to the present disclosure may be widely applied in green technology fields such as electric vehicles, battery charging stations, and other battery-using applications such as solar power generation and wind power generation.

Furthermore, the method for inspecting a cell electrode and the apparatus thereof according to the present disclosure may be used in eco-friendly electric vehicles (EVs), hybrid vehicles, and the like for preventing climate change by suppressing air pollution and greenhouse gas emissions.

According to an embodiment of the present disclosure, there is provided a method for inspecting a cell electrode, the method comprising: acquiring an electrode image using a first imager; acquiring a separator image using a second imager; aligning the acquired electrode image and the acquired separator image; compositing the electrode image and the separator image to generate a cell electrode image; and determining whether the cell electrode is defective using the composited cell electrode image.

In some non-limiting embodiments, the first imager may comprise a light source using radiation, and the second imager may comprise a light source having a wavelength region of any one of visible light, ultraviolet light, and infrared light.

In some non-limiting embodiments, the acquiring the electrode image and the acquiring the separator image may be performed sequentially or simultaneously.

In some non-limiting embodiments, at least one of the acquiring the electrode image and the acquiring the separator image may comprise: acquiring images from a plurality of angles while rotating a cell up to 360 degrees.

In some non-limiting embodiments, at least one of the acquiring the electrode image and the acquiring the separator image may comprise: acquiring a two-dimensional image; and reconstructing the two-dimensional image into a three-dimensional image.

In some non-limiting embodiments, the aligning the acquired electrode image and the acquired separator image may comprise: extracting feature points of each image and aligning the images by an image processor comprising an image processing algorithm.

In some non-limiting embodiments, the compositing the electrode image and the separator image may be performed based on a spacing and a position of each image.

In some non-limiting embodiments, the determining whether the cell electrode is defective may comprise: analyzing a spacing between electrodes or a position of a separator end point using the composited cell electrode image; and determining the cell electrode as defective if the spacing or the position deviates from a normal range.

In some non-limiting embodiments, the determining whether the cell electrode is defective may comprise: evaluating a possibility of interference or a short circuit between the electrodes by analyzing an overlapping portion of the electrode image and the separator image.

In some non-limiting embodiments, the determining whether the cell electrode is defective may comprise: applying a learning-based algorithm that automatically recognizes repetitive patterns or defects based on a comparison with past data.

In some non-limiting embodiments, the method may further comprise: storing the electrode image, the separator image, the composited cell electrode image, and a defect history and analysis results of the cell electrode obtained using the composited cell electrode image.

According to another embodiment of the present disclosure, there is provided an apparatus for inspecting a cell electrode, the apparatus comprising: a first imager configured to acquire an electrode image; a second imager configured to acquire a separator image; an image processor configured to align the acquired electrode image and the acquired separator image, and composite the electrode image and the separator image to generate a cell electrode image; an inspector configured to determine whether the cell electrode is defective using the composited cell electrode image; and a controller configured to control the first imager, the second imager, the image processor, and the inspector.

In some non-limiting embodiments, the first imager may comprise a light source using radiation, and the second imager may comprise a light source having a wavelength region of any one of visible light, ultraviolet light, and infrared light.

In some non-limiting embodiments, the first imager and the second imager may be each configured to acquire images from a plurality of angles while a cell is being rotated up to 360 degrees.

In some non-limiting embodiments, the controller may comprise a reconstructor configured to reconstruct two-dimensional images of the electrode and the separator into three-dimensional images.

In some non-limiting embodiments, the image processor may comprise an image processing algorithm, and may be configured to extract feature points of each image and align the images.

In some non-limiting embodiments, the inspector may be configured to: analyze a spacing between electrodes or a position of a separator end point using the composited cell electrode image; and determine the cell electrode as defective if the spacing or the position deviates from a normal range.

In some non-limiting embodiments, the inspector may be configured to evaluate a possibility of interference or a short circuit between the electrodes by analyzing an overlapping portion of the electrode image and the separator image using the composited cell electrode image.

In some non-limiting embodiments, the controller may be configured to control an alignment corrector configured to fine-tune an imaging angle for alignment accuracy of the electrode image and the separator image.

In some non-limiting embodiments, the apparatus may further comprise a storage configured to store the electrode image, the separator image, the composited cell electrode image, and a defect history and analysis results of the cell electrode obtained using the composited cell electrode image.

In some non-limiting embodiments, a method for inspecting a cell electrode and an apparatus thereof may be provided.

In some non-limiting embodiments, an effect is provided in that an electrode image and a separator image are respectively acquired, and then aligned and composited to generate a cell electrode image.

In some non-limiting embodiments, an effect is provided in that whether the cell electrode is defective may be inspected based on the cell electrode image.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart illustrating a method for inspecting a cell electrode according to some non-limiting embodiments or aspects according to the principles of the present disclosure.

FIG. 2 is a block diagram illustrating an apparatus for inspecting a cell electrode according to some non-limiting embodiments or aspects according to the principles of the present disclosure.

FIG. 3 is a schematic diagram illustrating a state in which an image is acquired by a first imager in a cell electrode inspection apparatus according to some non-limiting embodiments or aspects according to the principles of the present disclosure.

FIG. 4 is a schematic diagram illustrating a state in which an image is acquired by a second imager in a cell electrode inspection apparatus according to some non-limiting embodiments or aspects according to the principles of the present disclosure.

FIG. 5 is a schematic diagram illustrating a state in which images are acquired by a first imager and a second imager in a cell electrode inspection apparatus according to some non-limiting embodiments or aspects according to the principles of the present disclosure.

FIG. 6 is a schematic diagram illustrating a state in which images are acquired by a first imager and a second imager in a cell electrode inspection apparatus according to some non-limiting embodiments or aspects according to the principles of the present disclosure.

FIG. 7 is a schematic diagram illustrating a state in which images are acquired by a first imager and a second imager in a cell electrode inspection apparatus according to some non-limiting embodiments or aspects according to the principles of the present disclosure.

FIG. 8 is a diagram illustrating an electrode image acquired by a first imager according to some non-limiting embodiments or aspects according to the principles of the present disclosure.

FIG. 9 is a diagram illustrating a separator image acquired by a second imager according to some non-limiting embodiments or aspects according to the principles of the present disclosure.

FIG. 10 is a diagram illustrating a composited cell electrode image generated by compositing an electrode image and a separator image according to some non-limiting embodiments or aspects according to the principles of the present disclosure.

FIG. 11 is a diagram illustrating an electric vehicle to which the method for inspecting a cell electrode and the apparatus for inspecting a cell electrode are applied, according to some non-limiting embodiments or aspects according to the principles of the present disclosure.

### DETAILED DESCRIPTION

Hereinafter, embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described to as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information”. Here, the information may be used as a concept comprising the data.

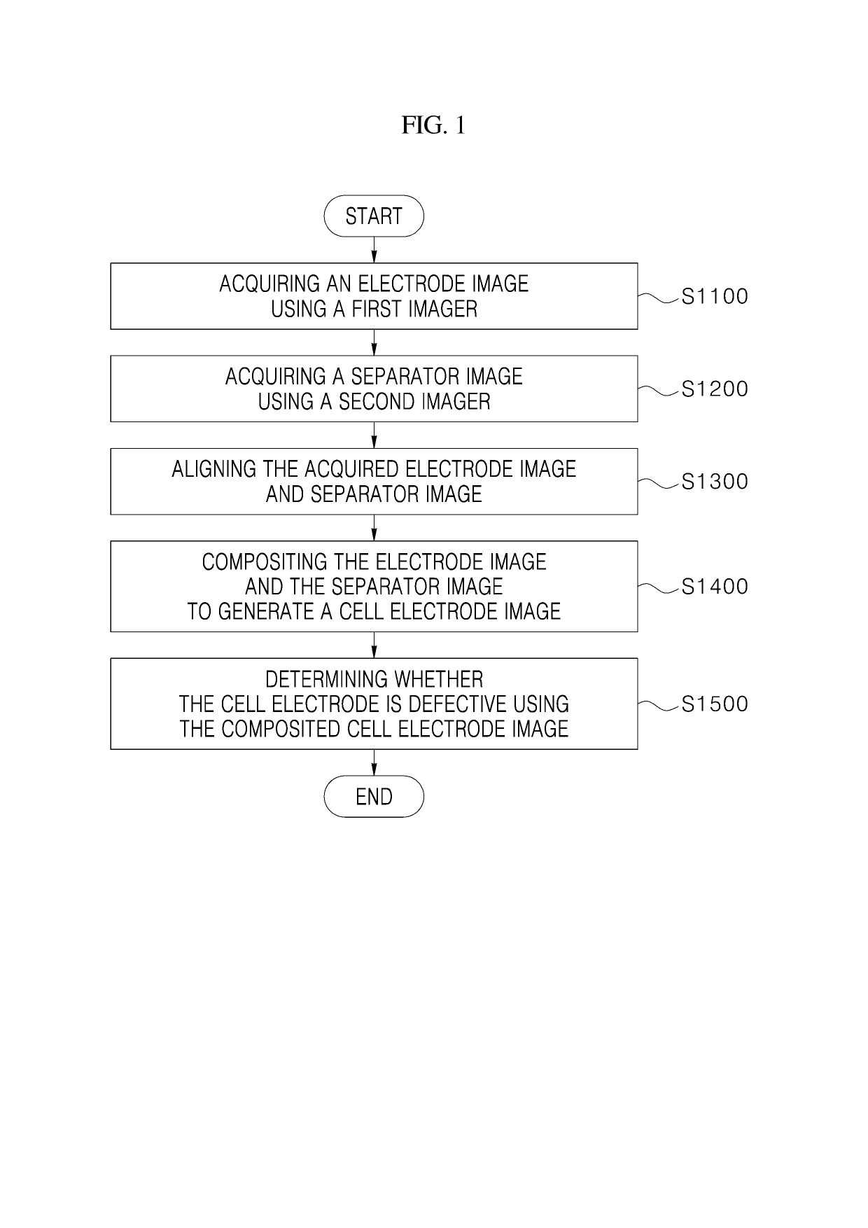

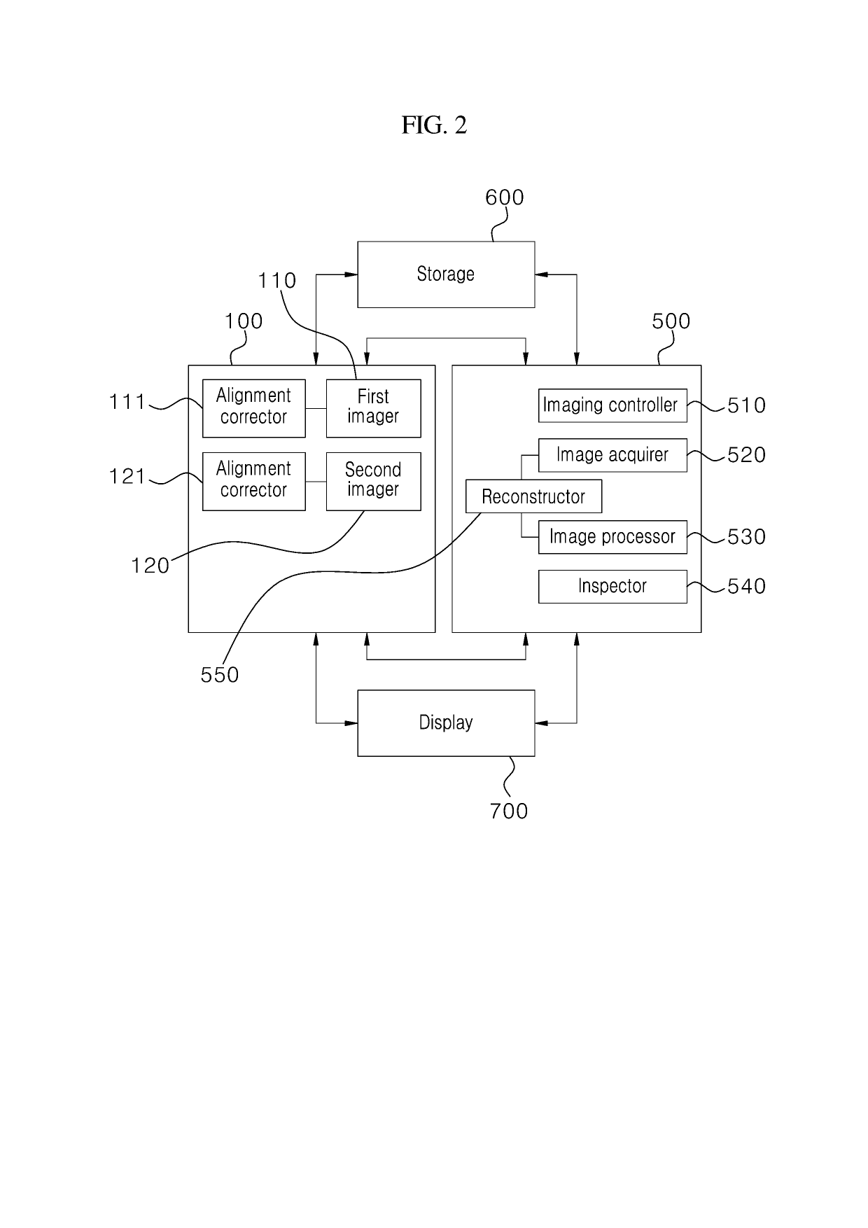

FIG. 1 is a flowchart illustrating a method for inspecting a cell electrode according to an embodiment of the present disclosure, and FIG. 2 is a block diagram illustrating an apparatus for inspecting a cell electrode according to an embodiment of the present disclosure.

Referring to FIG. 1 and FIG. 2, a method for inspecting a cell electrode according to the present disclosure may comprise acquiring an electrode image using a first imager 110 (S1100), acquiring a separator image using a second imager 120 (S1200), aligning the acquired electrode image and the acquired separator image (S1300), compositing the electrode image and the separator image to generate a cell electrode image (S1400) and determining whether the cell electrode is defective using the composited cell electrode image (S1500).

Accordingly, the present disclosure provides a method and apparatus for generating an overall shape of a cell electrode by respectively acquiring an electrode image and a separator image using the first imager 110 and the second imager 120, and then aligning and compositing the images. Through this, whether the cell electrode is defective may be precisely inspected and analyzed.

In the present disclosure, a cell is a rechargeable secondary battery. The present disclosure may be applied to such a cell, a battery module comprising a plurality of battery cells, or a battery pack comprising a plurality of battery modules, and may be applied regardless of their shape or arrangement.

In the present disclosure, electrode means a cathode (positive electrode) and/or an anode (negative electrode) inside the cell 10 , and cell electrode may mean a structure comprising the cathode and the anode inside the cell, or a cathode/separator/anode structure, and these terms may be used interchangeably for convenience.

According to an embodiment of the present disclosure, first, an electrode image may be acquired using the first imager 110 (S1100).

According to an embodiment of the present disclosure, the first imager 110 is an apparatus for imaging an electrode, and may comprise a light source using radiation. For example, the first imager 110 may use a radiation technology such as X-ray CT. X-ray CT (Computed Tomography) can capture the internal structure of the electrode from various angles using X-rays. This allows for the clear identification of the position, structure, thickness, density differences, etc., of the electrode.

For example, when imaging the electrodes of a lithium-ion battery, X-ray CT may be used to check the stacked state of the cathode (positive electrode) and the anode (negative electrode), and to analyze the thickness, arrangement state, internal defects, etc., of each electrode.

According to an embodiment of the present disclosure, a separator image may be acquired using the second imager 120 (S1200).

According to an embodiment of the present disclosure, the second imager 120 is an apparatus for imaging a separator, and may comprise a light source having a wavelength region of any one of visible light (380-750 nm), ultraviolet (UV) light (100-400 nm), and infrared (IR) light (750 nm or more).

Since the separator is composed of a transparent or translucent material, it is difficult to acquire an image using only X-rays. Therefore, by using visible, ultraviolet, or infrared wavelengths, the thickness, surface state, or transparency of the separator may be identified.

According to an embodiment of the present disclosure, the second imager 120 using visible light can observe the surface state or color change of the separator, and the second imager 120 using ultraviolet light, which has a shorter wavelength than visible light, can detect surface defects, micro-damage, etc., of the separator. Furthermore, in the case of infrared light, it is possible to identify thickness changes, internal structural abnormalities, etc., of the separator. As it can penetrate materials more deeply than visible light, it may be more useful for observing the internal state of the separator.

That is, a light source having an appropriate wavelength may be selected and applied depending on the type of separator or the type of defect to be observed, which may be implemented (if necessary) by adjusting the wavelength of a single second imager 120, or by different second imagers 120 having light sources of different wavelengths.

For example, if the surface state of the separator is imaged using visible light, changes in the separator's thickness, the presence of fine pores, or damage may be detected.

According to an embodiment of the present disclosure, the first imager 110 and the second imager 120 are controlled by an imaging controller 510. The electrode and separator images, captured by an imaging sensor, are converted into electrical signals by an image acquirer 520 of the controller 500, allowing additional image processing to be performed by the image processor 530. These processes may all fall within the scope of operation of the controller 500.

According to an embodiment of the present disclosure, the step of acquiring the electrode image (S1100) and the step of acquiring the separator image (S1200) may be performed sequentially or simultaneously, depending on the arrangement or operational state of the first imager 110 and the second imager 120. That is, according to an embodiment of the present disclosure, the electrode image and the separator image may be acquired sequentially or simultaneously. Sequential acquisition allows for the optimization of respective imaging conditions, as the imaging methods for the electrode and the separator are different. Simultaneous acquisition can reduce the time required for imaging, and if imaging is performed at the same position, the relative positions of the electrode and separator can be accurately maintained, thereby increasing the accuracy of image alignment and compositing.

Furthermore, according to an embodiment of the present disclosure, the step of acquiring the electrode image (S1100) and the step of acquiring the separator image (S1200) may comprise acquiring images from a plurality of angles while rotating the cell 10 up to 360 degrees.

That is, images may be acquired from various angles by fixing the cell 10 to a rotating stage 20 or the like, which can rotate the cell 10 360 degrees. This rotational imaging method allows for the three-dimensional identification of the overall shape and structure of the electrode or separator by observing various sides of the cell 10. This may be useful for identifying minute defects, stacking failures, or cracks in the electrode, or for identifying the position, thickness, or surface damage of the separator.

Furthermore, by acquiring images from a plurality of angles while rotating the cell 10 up to 360 degrees, a series of images can be acquired from different angles. The imaging angle may be adjusted at regular intervals, and all the acquired images are combined to form the overall structure. By acquiring images from a plurality of angles in this manner, it is possible to identify parts that are not visible from specific angles or hidden defects of the electrode and separator, and to check for misalignment or structural defects of the cell electrode.

For example, if a total of 36 images are acquired while rotating the cell 10 in 10-degree increments, the images acquired from each angle may be composited to reconstruct the entire 3D shape of the electrode or separator. The more precise the imaging angles, the more accurate the 3D structure the composited image can show, and the positional relationship and structural state between the electrode and the separator can be identified more three-dimensionally.

Furthermore, the step of acquiring the electrode image (S1100) and the step of acquiring the separator image (S1200) may comprise a process of acquiring two-dimensional (2D) images and then reconstructing them into three-dimensional (3D) images. That is, after 2D images of the electrode or separator are acquired from multiple angles, 3D images may be reconstructed based on the acquired 2D images. Through this process, the overall 3D structure of the electrode can be identified.

According to an embodiment of the present disclosure, the acquisition of 2D images of the electrode or separator involves acquiring 2D images of the electrode or separator while rotating the cell 10 at various angles. The 2D images represent the cross-section and structure of the electrode or separator captured at each respective angle.

According to an embodiment of the present disclosure, the acquisition of 3D images of the electrode or separator is performed by acquiring 2D images and then reconstructing them into 3D images. The 2D images obtained through radiation imaging, such as X-ray CT, or through visible light, ultraviolet light, or infrared light, may be composited and converted into 3D images through a software algorithm of an image processor 530 or the like.

In an embodiment of the present disclosure, "reconstructing into 3D images" means that the entire structure of the electrode or separator can be three-dimensionally represented based on the plurality of 2D images acquired from multiple angles. By compositing the images acquired at each angle using the image processor 530, it is possible to accurately identify not only the thickness, position, and surface defects of the electrode or separator, but also non-uniform thickness distribution, surface damage, and the presence of defects, and to visualize these characteristics.

According to an embodiment of the present disclosure, in the step of acquiring the electrode image (S1100) and the step of acquiring the separator image (S1200), the first imager 110 and the second imager 120 may be arranged in the same direction with respect to the cell 10, or may be arranged in arbitrary directions with respect to the cell 10 to acquire images.

That is, according to an embodiment of the present disclosure, in the process of acquiring the electrode image and the separator image, the first imager 110 (e.g., X-ray CT) and the second imager 120 (e.g., visible light/ultraviolet/infrared) may be arranged in the same direction or in different arbitrary directions.

This means that the arrangement direction of the imaging part 100 can be variously adjusted according to the imaging angle and inspection purpose of the battery cell, and may be adjusted according to the structure, thickness, position, etc., of the electrode and the separator.

According to an embodiment of the present disclosure, if the first imager 110 and the second imager 120 are arranged in the same direction, the electrode and the separator can be imaged simultaneously at the same time point. If they are arranged in different directions, the electrode and the separator can be imaged independently at different time points, allowing for a more three-dimensional analysis.

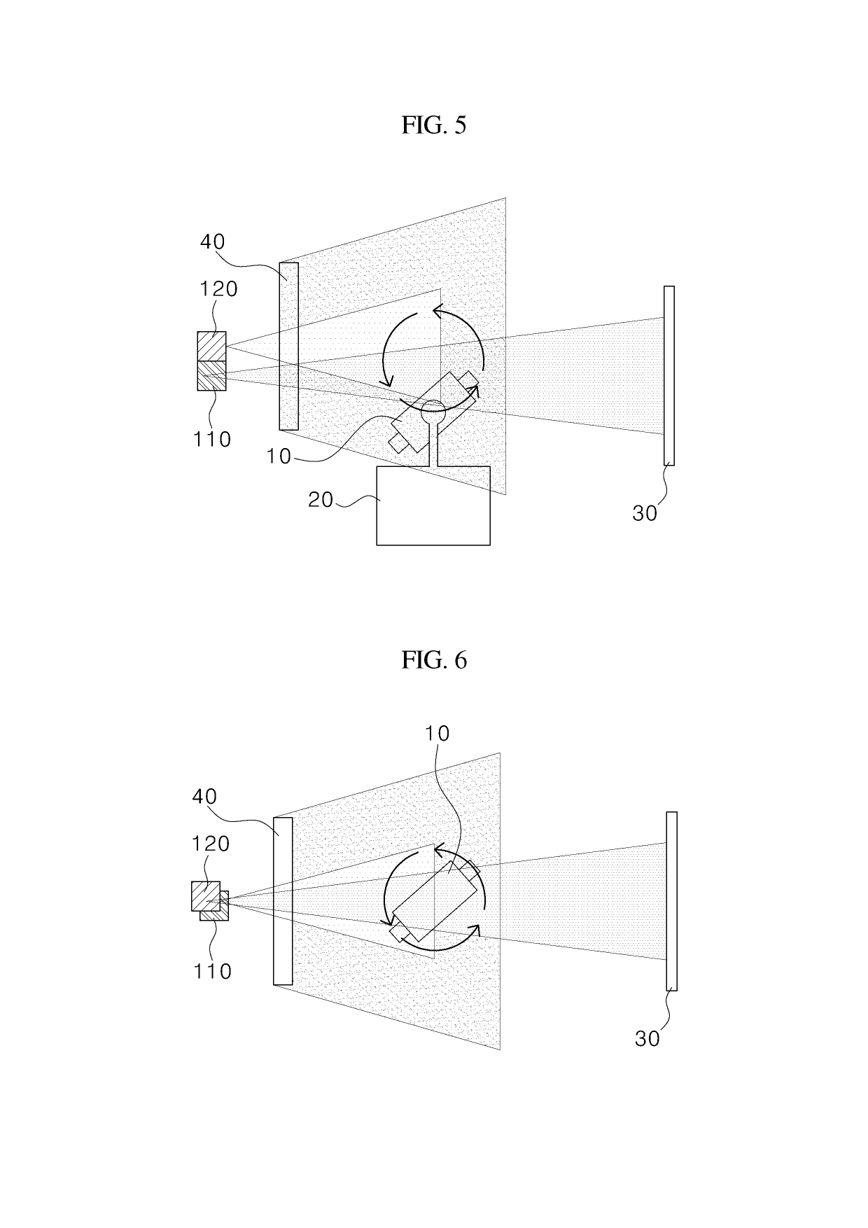

For example, if it is desired to image the electrode and the separator of the cell 10 simultaneously, the first imager 110 and the second imager 120 may be arranged in the same direction (see FIG. 5 and FIG. 6) to image the cell 10 in a single rotation. That is, they are arranged to image simultaneously at the same angle with respect to the center of rotation of the cell 10.

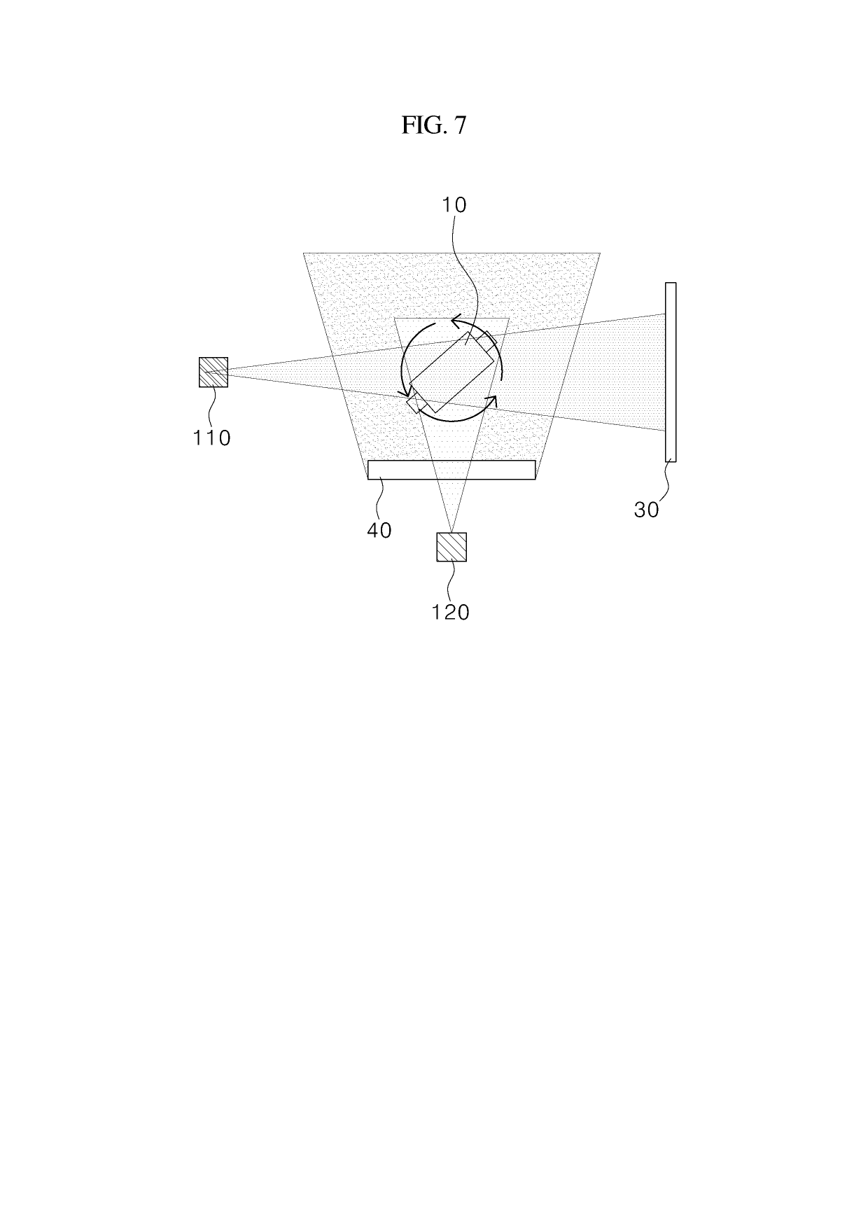

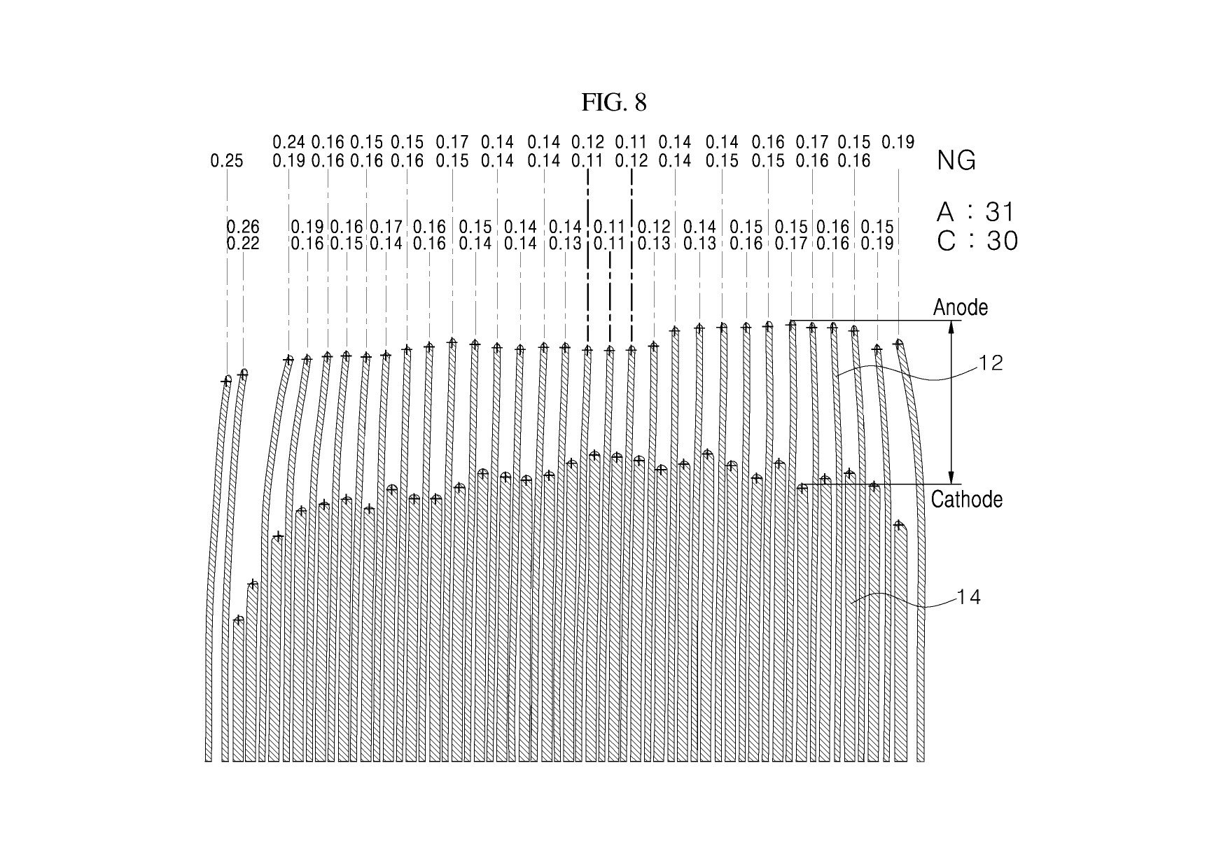

Furthermore, if it is desired to image the electrode and the separator of the cell 10 in more detail at different time points, imaging may be performed by arranging the first imager 110 on the front side of the cell 10 and the second imager 120 on the side of the cell 10. That is, the first imager 110 and the second imager 120 may be arranged at a 90-degree angle (see FIG. 7). This allows for imaging the structure from different angles, enabling a more detailed analysis.

According to an embodiment of the present disclosure, the acquired electrode image is aligned and the acquired separator image is aligned (S1300). This is a process of aligning the electrode image and the separator image after they are respectively acquired, and involves arranging the acquired images at their precise positions according to the internal structure of the cell 10. The accuracy of image alignment can be a critical factor for the subsequent image compositing and defect determination.

According to an embodiment of the present disclosure, the step of aligning the images may comprise a process of extracting feature points of each image and aligning them, performed by an image processor 530 comprising an image processing algorithm.

According to an embodiment of the present disclosure, the feature points of the images (unique points in an image that are distinct from other parts) may include the boundaries of the electrode, the surface pattern of the separator, the intersection points of the electrode and the separator, the separator end points, etc. The images are made to overlap by precisely matching their positions and angles based on these feature points.

For example, in the case of an electrode image acquired by X-ray CT, the image processor 530 comprising the image processing algorithm extracts the boundaries and interlayer structures of the electrode as feature points and aligns the images using them. In this process, the images acquired at different angles are precisely matched to each other.

According to an embodiment of the present disclosure, the image processor 530 refers to a hardware and software module that executes an image processing algorithm. This module analyzes the electrode and separator images, extracts feature points, and performs the alignment and compositing processes.

That is, the image processor 530 analyzes the position, rotation, size, etc., of each acquired image to perform optimal alignment, thereby ensuring that the composited cell electrode structure can be accurately represented.

According to an embodiment of the present disclosure, the aligned electrode image and separator image may be composited to generate a cell electrode image (S1400).

This involves compositing the aligned electrode image and separator image into a single integrated image by overlapping them at the correct relative position and spacing, and the two images must be accurately aligned and composited. That is, the composited image comprehensively represents the electrode arrangement and the state of the separator inside the cell 10, and thus can provide important data for subsequent defect determination.

For example, by compositing the electrode image and the separator image, it is possible to visualize three-dimensionally how the cathode (positive electrode) and the anode (negative electrode) are arranged, and whether the separator is properly positioned between them.

According to an embodiment of the present disclosure, when compositing the electrode image and the separator image, they may be composited based on the spacing and position of each image.

The spacing of the images may be the distance separating the electrode and the separator inside the actual cell 10, and the position may mean the exact coordinates and arrangement state that the electrode and separator occupy inside the cell 10. That is, the cell 10 can operate normally only when the electrode and the separator are in their correct positions.

For example, in the image compositing of a battery cell where the electrode and separator overlap, if the spacing between electrodes is 1 mm and the separator thickness is 0.1 mm, the image is composited by reflecting this spacing and thickness information. That is, by compositing based on the spacing and position of the images, the relative structure and positional relationship of the electrode and the separator can be accurately reproduced.

According to an embodiment of the present disclosure, the step of determining whether the cell electrode is defective may be performed using the composited cell electrode image (S1500).

This may be performed by an inspector 540. The defect inspection involves analyzing the spacing between electrodes, the state and position of the separator, etc., in the composited cell electrode image, and determining it as defective if it deviates from a normal range.

Inspection items may include whether the spacing between electrodes is too narrow or too wide, whether the separator is correctly positioned between the cathode and the anode, or whether there is damage to the separator. For example, if the spacing between electrodes in the composited image is so narrow that there is a possibility of a short circuit, or if the separator end points are not accurate, failing to completely separate the electrodes, it may be determined as defective.

According to an embodiment of the present disclosure, the inspection of whether the cell electrode is defective may involve analyzing the spacing between electrodes using the composited cell electrode image and determining it as defective if it deviates from a normal range; analyzing the position of the separator end points using the composited cell electrode image and determining it as defective if it deviates from a normal range; or evaluating the possibility of interference or a short circuit between electrodes by analyzing the overlapping portion of the electrode image and the separator image.

Analysis of the spacing between electrodes involves measuring the distance between the cathode and the anode by analyzing the composited image, comparing it to a normal range, and automatically detecting any portion that deviates from the normal range. Analysis of the separator end points involves analyzing the composited image to check whether the separator end points are positioned to completely cover the electrodes, or whether they are within a certain normal range. Analysis of the overlap between the electrode image and the separator image evaluates the possibility of interference or a short circuit between electrodes, and assesses whether the insulating role of the separator is being properly performed.

Furthermore, according to an embodiment of the present disclosure, the step of determining whether the cell electrode is defective (S1500) may comprise applying a learning-based algorithm that automatically recognizes repetitive patterns or defects based on a comparison with past data. That is, data-based defect detection using artificial intelligence and machine learning may be performed, and defects in the cell electrode can be identified more accurately and quickly through repetitive pattern analysis.

According to an embodiment of the present disclosure, the electrode image, the separator image, the composited cell electrode image, and a defect history and analysis results of the cell electrode obtained using the composited cell electrode image may be stored in a storage 600, and may be used for future data utilization and analysis.

FIG. 2 is a diagram illustrating an example of an apparatus for inspecting a cell electrode according to an embodiment of the present disclosure. Detailed descriptions of parts of the cell electrode inspection apparatus according to the present disclosure that are redundant with the above-described cell electrode inspection method will be omitted.

Referring to FIG. 2, an apparatus for inspecting a cell electrode according to an embodiment of the present disclosure may comprise a first imager 110 configured to acquire an electrode image; a second imager 120 configured to acquire a separator image; an image processor 530 configured to align the acquired electrode image and the acquired separator image, and composite the electrode image and the separator image to generate a cell electrode image; an inspector 540 configured to determine whether the cell electrode is defective using the composited cell electrode image; and a controller 500 configured to control the first imager 110, the second imager 120, the image processor 530, and the inspector 540.

Accordingly, the present disclosure inspects whether the cell electrode is defective by acquiring an electrode image and a separator image respectively using the first imager 110 and the second imager 120, and then aligning and compositing them in the image processor 530 to generate the overall shape of the cell electrode. Furthermore, the controller 500 controls the first imager 110, the second imager 120, the image processor 530, and the inspector 540 to enable efficient inspection of the cell electrode's state and accurate determination of whether it is defective.

According to an embodiment of the present disclosure, the first imager 110 may comprise a light source using radiation, and the second imager 120 may comprise a light source having a wavelength region of any one of visible light, UV, and IR. This is so that the first imager 110 and the second imager 120 can image the electrode and the separator more accurately, and different light sources and wavelengths may be used.

According to an embodiment of the present disclosure, the first imager 110 can capture the electrode structure from multiple angles via X-ray CT imaging to identify the position, density, structural defects, etc., of the electrode, and the second imager 120 can image the separator to more accurately identify surface defects or cracks in the separator.

By using these different imaging parts 100, which are respectively optimized for imaging the electrode and the separator, the first imager 110 and the second imager 120 act in a complementary manner to enable a comprehensive analysis of the state of the electrode and the separator and to accurately detect defects.

According to an embodiment of the present disclosure, the first imager 110 and the second imager 120 may each acquire images from a plurality of angles while the cell 10 is being rotated up to 360 degrees. Hereby, images can be acquired from a plurality of angles while rotating the cell 10 up to 360 degrees, and the 3D structure of the electrode and separator can be precisely analyzed. That is, by combining the 2D images acquired from various angles to reconstruct the 3D structure of the cell 10, the relative position and arrangement of the electrode and separator can be accurately visualized.

According to an embodiment of the present disclosure, the controller 500 may comprise a reconstructor 550 configured to reconstruct 2D images of the electrode and the separator, which are acquired from various angles, into 3D images. The reconstructor 550 according to an embodiment of the present disclosure analyzes the 2D images acquired from the multiple angles and reconstructs them into a 3D image, thereby enabling the structure of the cell electrode to be three-dimensionally identified. This reconstructor 550 is a software and hardware module that functions to process 2D images and composite them into a 3D image. It analyzes feature points of the images acquired from each imaging angle, and accurately composites and aligns them to represent the 3D structure of the electrode. The reconstruction process performed by this reconstructor 550 involves analyzing the 2D images acquired from various angles, identifying the feature points and positional relationships between the images to accurately align them, and compositing the aligned 2D images to reconstruct the 3D structure of the electrode.

According to an embodiment of the present disclosure, the first imager 110 and the second imager 120 may be arranged in the same direction with respect to the cell 10, or may be arranged in arbitrary directions with respect to the cell 10. If the electrode and the separator are imaged from the same direction, alignment and analysis may be facilitated when compositing the two images. If they are arranged in arbitrary directions, there is an advantage of being able to check various aspects, and they may be appropriately selected and arranged according to the respective process environment.

According to an embodiment of the present disclosure, the cell electrode inspection apparatus may comprise an image processor 530 that comprises an image processing algorithm and extracts feature points of each image to align the images. Through this, accurate alignment and compositing of the electrode image and the separator image may be performed, allowing for the accurate identification of the spacing between electrodes, the position and thickness state of the separator.

According to an embodiment of the present disclosure, the inspector 540 may, using the composited cell electrode image, automatically calculate the spacing between electrodes and determine it as defective if it deviates from a normal range; may, using the composited cell electrode image, analyze the position of the separator end points and determine it as defective if it deviates from a normal range; and may, using the composited cell electrode image, evaluate the possibility of interference or a short circuit between electrodes by analyzing the overlapping portion of the electrode image and the separator image.

According to an embodiment of the present disclosure, the controller 500 may control an alignment corrector 111, 121 that can fine-tune an imaging angle for alignment accuracy of the electrode image and the separator image. This is to enhance the quality of each image during the imaging process and to improve the accuracy of the inspection results. For example, if the rotation angle of the cell 10 is misaligned while imaging the cell 10, or if the camera's focus is incorrect, the alignment corrector 111, 121 automatically sets the imaging angle to acquire the image accurately and ensures it is imaged in an aligned state. This may be connected to each imaging part and controlled by the controller 500.

According to an embodiment of the present disclosure, the cell electrode inspection apparatus may comprise a storage 600 configured to store the electrode image, the separator image, the composited cell electrode image, and a defect history and analysis results of the cell electrode obtained using the composited cell electrode image. This storage 600 may also be controlled by the controller 500 and may be linked with the imaging part 100.

According to an embodiment of the present disclosure, the cell electrode inspection apparatus may comprise a display 700 configured to visually display the composited cell electrode image through a user interface. This allows the user to easily identify the state, position, spacing, etc., of the electrode and separator by displaying the composited cell electrode image on a monitor or screen via the display 700. This display 700 may also be controlled by the controller 500 and may be connected to the imaging part 100.

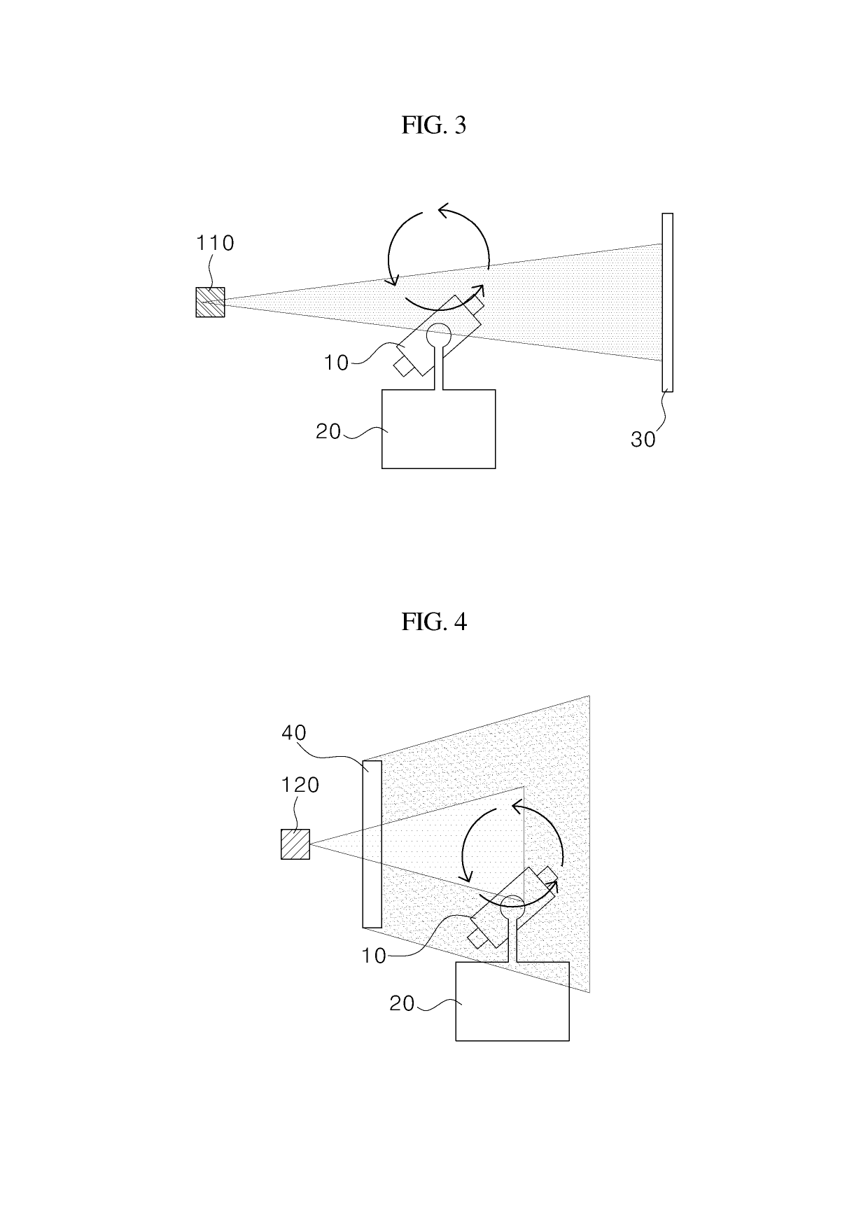

FIG. 3 is a schematic diagram illustrating a state in which an image is acquired by the first imager 110 in the cell electrode inspection apparatus according to an embodiment of the present disclosure. The cell 10 is fixed to a rotating stage 20 or the like, which can rotate the cell 10 360 degrees, and an X-ray light source is used as the first imager 110. A detector 30 is positioned on one side, and an electrode image can be acquired by imaging the electrode inside the cell 10.

FIG. 4 is a schematic diagram illustrating a state in which an image is acquired by the second imager 120 in the cell electrode inspection apparatus according to an embodiment of the present disclosure. The cell 10 is fixed to a rotating stage 20 or the like, which can rotate the cell 10 360 degrees, and a visible light, ultraviolet, or infrared light source is used as the second imager 120 to acquire a separator image by imaging the separator inside the cell 10. Furthermore, if necessary, illumination 40 may be installed.

As such, images may be acquired from various angles by fixing the cell 10 to a rotating stage 20, which can rotate the cell 10 360 degrees. This rotational imaging method allows for the three-dimensional identification of the overall shape and structure of the electrode or separator by observing various sides of the cell 10. This may be useful for identifying minute defects, stacking failures, or cracks in the electrode, or for identifying the position, thickness, or surface damage of the separator.

Based on FIG. 3 and FIG. 4, the electrode image and the separator image, which are sequentially acquired by the first imager 110 and the second imager 120 respectively, are aligned and composited, and whether the cell electrode is defective is inspected using the composited cell electrode image.

FIG. 5 to FIG. 7 are schematic diagrams illustrating a state in which images are acquired by the first imager 110 and the second imager 120 in the cell electrode inspection apparatus according to an embodiment of the present disclosure. This illustrates a state in which the electrode image and the separator image are acquired simultaneously by the first imager 110 and the second imager 120. FIG. 5 is a side view of the cell 10, showing the first imager 110 and the second imager 120 arranged in one direction relative to the cell 10. FIG. 6 is a top view of the cell 10, showing the first imager 110 and the second imager 120 arranged in one direction relative to the cell 10. FIG. 7 is a top view of the cell 10, showing the first imager 110 and the second imager 120 arranged in one direction relative to the cell 10 and at a 90-degree angle relative to that direction. In each figure, a detector 30 for the first imager 110 and illumination 40 for the second imager 120 are arranged.

According to an embodiment of the present disclosure, if the first imager 110 and the second imager 120 are arranged in the same direction, the electrode and the separator can be imaged simultaneously at the same time point. If they are arranged in different directions, the electrode and the separator can be imaged independently at different time points, allowing for a more three-dimensional analysis.

For example, as illustrated in FIG. 5 and FIG. 6, if it is desired to image the electrode and the separator of the cell 10 simultaneously, the first imager 110 and the second imager 120 may be arranged in the same direction to image the cell 10 in a single rotation. That is, they are arranged to image simultaneously at the same angle with respect to the center of rotation of the cell 10.

Furthermore, as illustrated in FIG. 7, if it is desired to image the electrode and the separator of the cell 10 in more detail at different time points, imaging may be performed by arranging the first imager 110 on the front side of the cell 10 and the second imager 120 on the side of the cell 10. That is, the first imager 110 and the second imager 120 may be arranged at a 90-degree angle. This allows for imaging the structure from different angles, enabling a more detailed analysis.

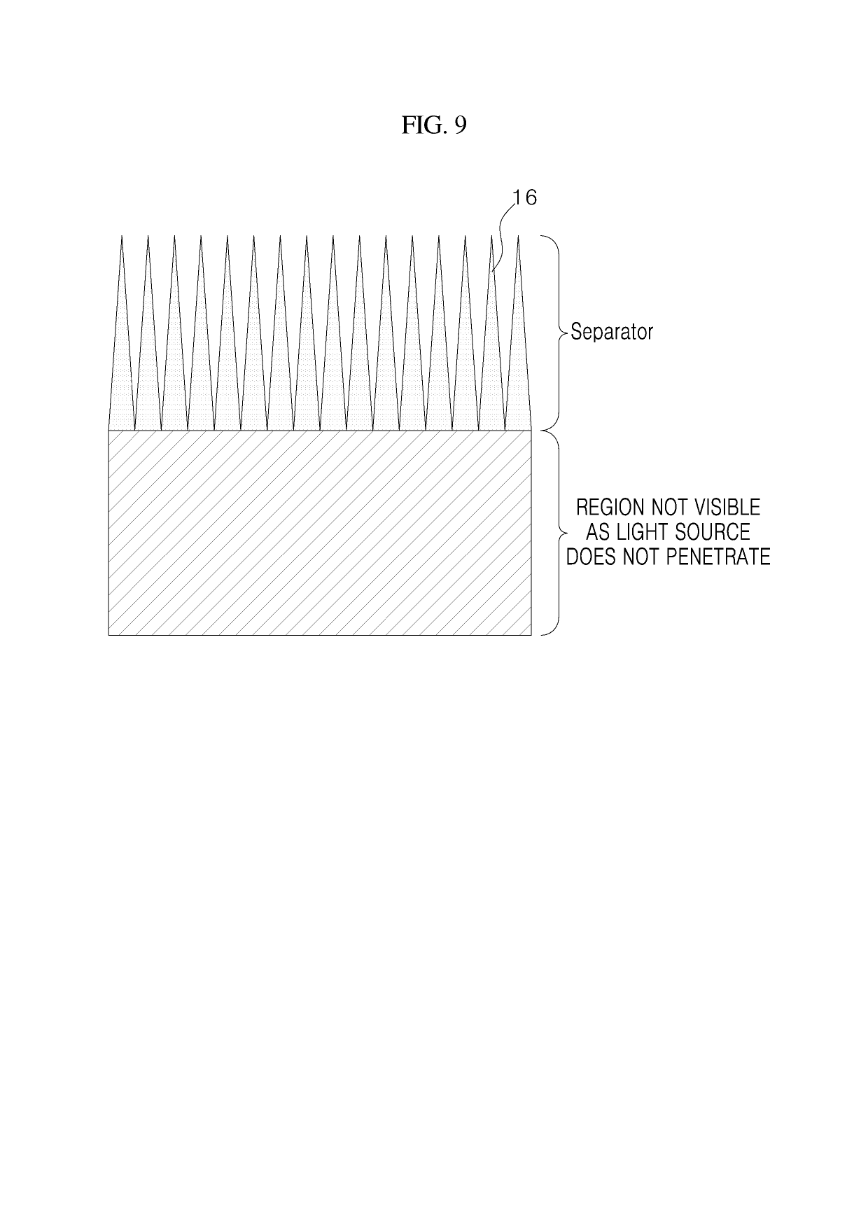

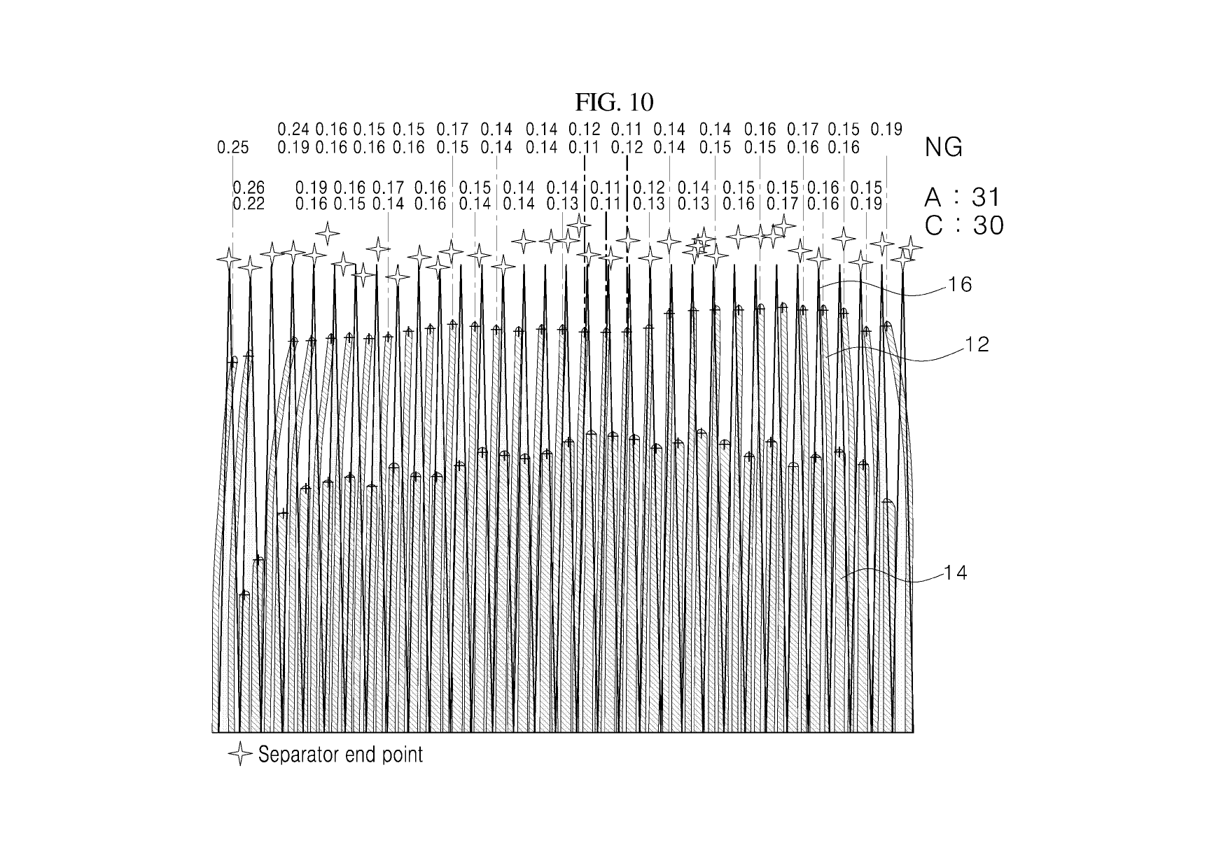

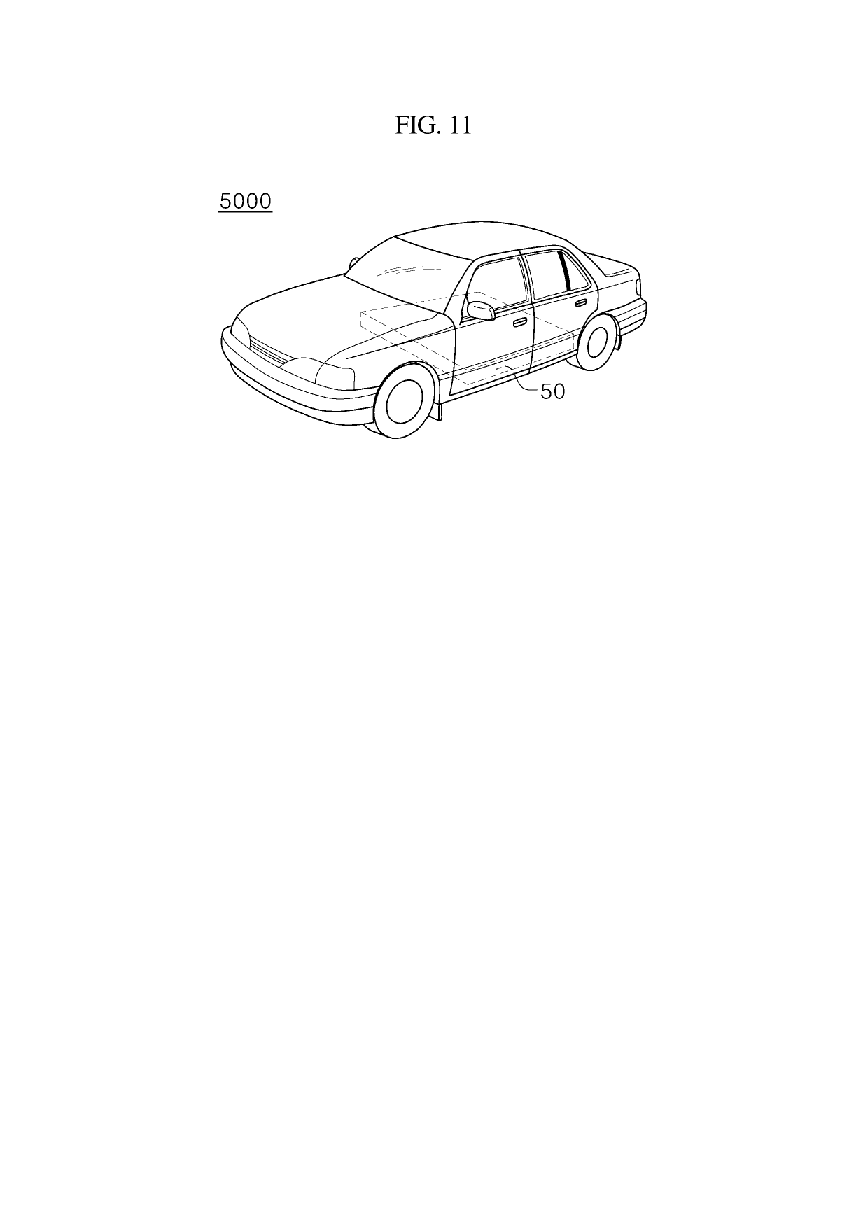

FIG. 8 is a diagram illustrating an electrode image acquired by the first imager 110 according to an embodiment of the present disclosure, FIG. 9 is a diagram illustrating a separator image acquired by the second imager 120 according to an embodiment of the present disclosure, and FIG. 10 is a diagram illustrating a composited cell electrode image generated by compositing an electrode image and a separator image according to an embodiment of the present disclosure.

FIG. 8 is an electrode image showing the structure of the cathode 14 and the anode 12 within the cell 10, for which a defect determination is made by automatic inspection. As illustrated, the positional relationship between the anode 12 and the cathode 14 is accurately represented, and the spacing between each electrode is displayed as numerical values. For example, the numerical values shown at the top of the image represent the values of the spacing between electrodes, and a determination of Normal or NG is made based on a normal range.

As illustrated in FIG. 8, the electrode structure imaged by the first imager 110 shows a structure in which the anode 12 and the cathode 14 are alternately arranged, and the spacing between the two electrodes plays an important role in the electrical characteristics and performance of the battery cell. The lines displayed at the top of the figure indicate the spacing and thickness between the electrodes. These numerical values are displayed for the purpose of checking whether they are acceptable or defective according to the actual inspection normal range.

FIG. 9 is an image of the separator 16 within the cell. The separator 16 is imaged using visible light, ultraviolet light, infrared light, etc., and this is used to clearly identify the state of the separator 16 inside the electrode using wavelengths different from X-rays. The separator 16 serves to insulate the electrodes, and the state of the separator 16 must be accurately identified to evaluate the possibility of a short circuit between the electrodes.

The lower portion of FIG. 9 shows a part where the separator 16 is not clearly visible because the electrode is thick. This indicates a region where the separator 16 cannot be clearly imaged because the light source of the second imager 120 does not penetrate due to the electrode. The analysis of this region can be supplemented through fine-tuning of the imaging equipment and angles.

FIG. 10 illustrates a composited cell electrode image generated by compositing the electrode (FIG. 8) and separator (FIG. 9) images. Through this image, it is possible to identify at a glance whether the separator 16 is properly covering the electrodes or whether the spacing between the electrodes is normal.

In FIG. 10, the positions of the separator 16 end points are marked (asterisks), and through this, it can be confirmed whether the separator 16 is properly covering the electrodes. The asterisk marks shown in the image represent the separator 16 end points, and it is checked whether the end points are accurately aligned according to the normal range for the electrodes.

The "NG" (Not Good) displayed in the upper right corner signifies a defect determination result. If the analysis of the spacing between each electrode and the state of the separator 16 deviates from the normal range, it is marked as defective, and the defective part can be clearly indicated through numerical values and position information.

As such, from FIG. 8 to FIG. 10, the performance and stability of the battery cell can be judged by checking whether the spacing between electrodes deviates from the normal range based on the analysis of the spacing between electrodes. From the identification of the position of the separator 16 end points, the risk of a short circuit between electrodes can be identified and quality can be ensured by checking whether the separator 16 is properly covering the electrodes. Furthermore, the state of the electrode and the separator 16 can be visually checked in real time, and whether they are defective can be quickly determined through an automatic inspection system.

FIG. 11 is a diagram illustrating an electric vehicle to which the apparatus for inspecting a cell electrode according to an embodiment of the present disclosure may be applied, or which uses the method for inspecting a cell electrode according to an embodiment of the present disclosure.

Referring to FIG. 11, an electric vehicle 5000, on which the inspection of the cell electrode has been performed using the apparatus for inspecting a cell electrode according to an embodiment of the present disclosure, may be driven by receiving power necessary for driving an electric motor from a battery pack 50, on which the inspection of the cell electrode has been performed by acquiring a cell electrode image comprising the electrode and the separator. The electric vehicle 5000 may, although not illustrated, perform the inspection of the cell electrode using the cell electrode inspection method and apparatus described with reference to FIG. 1 to FIG. 10.

Furthermore, the electric vehicle 5000 may comprise battery cells for which the inspection of the cell electrode has been completed by applying the cell electrode inspection method or apparatus according to an embodiment of the present disclosure.

Therefore, the stability of the cell electrodes in the battery pack of the electric vehicle 5000 may be inspected.

Meanwhile, the electric vehicle 5000 according to an embodiment of the present disclosure may further comprise a control system (e.g., an ECU (Electronic Control Unit)) that communicates with a battery management system via a designated communication method (e.g., CAN (Control Area Network)), and at least one display that provides (e.g., displays) various information of the electric vehicle 5000 (e.g., state information of the battery pack or cells included in the battery pack, abnormal state information detected by the cell electrode inspection apparatus according to the present disclosure, the electrode image, the separator image, the composited cell electrode image, driving information of the electric vehicle 5000, etc.).

Furthermore, the present disclosure may be applied to various devices that operate by receiving power from a battery module or a battery pack 50 comprising cells for which the inspection of the cell electrode has been performed by the cell electrode inspection apparatus or method according to an embodiment of the present disclosure. For example, the cell electrode inspection apparatus according to an embodiment of the present disclosure may be applied to electric mobility devices (e.g., hybrid vehicles, electric bicycles, electric motorcycles, etc.), Energy Storage Systems (ESS), and the like.

Various embodiments of the present disclosure may be implemented as software (e.g., a program) comprising one or more instructions stored on a machine-readable storage medium (e.g., internal memory or external memory). For example, a processor of a machine (e.g., an electronic device) may call at least one instruction from the one or more instructions stored in the storage medium and execute it. This enables the machine to be operated to perform at least one function according to the at least one called instruction. The one or more instructions may include code generated by a compiler or code that can be executed by an interpreter. The machine-readable storage medium may be provided in the form of a non-transitory storage medium. Here, 'non-transitory' merely means that the storage medium is a tangible device and does not include a signal (e.g., an electromagnetic wave), and this term does not distinguish between cases where data is stored semi-permanently and cases where data is stored temporarily in the storage medium.

A method according to various embodiments of the present disclosure may be provided included in a computer program product. The computer program product may be transacted between a seller and a buyer as a commodity. The computer program product may be distributed in the form of a machine-readable storage medium (e.g., compact disc read only memory (CD-ROM)), or may be distributed online (e.g., downloaded or uploaded) through an application store (e.g., Play Store™) (or directly between two user devices (e.g., smartphones)). In the case of online distribution, at least a part of the computer program product may be at least temporarily stored or temporarily generated in a machine-readable storage medium such as a memory of a manufacturer's server, an application store's server, or a relay server.

The foregoing descriptions are merely examples applying the principles of the present disclosure, and other configurations may be further included within the scope of the present disclosure. For example, at least some of the various embodiments of the present disclosure described above may be combined.

What is claimed is:

1. A method for inspecting a cell electrode, comprising:
acquiring an electrode image using a first imager;
acquiring a separator image using a second imager;
aligning the acquired electrode image and the acquired separator image;
compositing the electrode image and the separator image to generate a cell electrode image; and
determining whether the cell electrode is defective using the composited cell electrode image.

2. The method of claim 1, wherein the first imager comprises a light source using radiation, and the second imager comprises a light source having a wavelength region of any one of visible light, ultraviolet light, and infrared light.

3. The method of claim 1, wherein the acquiring the electrode image and the acquiring the separator image are performed sequentially or simultaneously.

4. The method of claim 1, wherein at least one of the acquiring the electrode image and the acquiring the separator image comprises:
acquiring images from a plurality of angles while rotating a cell up to 360 degrees.

5. The method of claim 4, wherein at least one of the acquiring the electrode image and the acquiring the separator image comprises:
acquiring a two-dimensional image; and
reconstructing the two-dimensional image into a three-dimensional image.

6. The method of claim 1, wherein the aligning the acquired electrode image and the acquired separator image comprises:
extracting feature points of each image and aligning the images by an image processor comprising an image processing algorithm.

7. The method of claim 1, wherein the compositing the electrode image and the separator image is performed based on a spacing and a position of each image.

8. The method of claim 1, wherein the determining whether the cell electrode is defective comprises:
analyzing a spacing between electrodes or a position of a separator end point using the composited cell electrode image; and
determining the cell electrode as defective if the spacing or the position deviates from a normal range.

9. The method of claim 1, wherein the determining whether the cell electrode is defective comprises:
evaluating a possibility of interference or a short circuit between the electrodes by analyzing an overlapping portion of the electrode image and the separator image.

10. The method of claim 1, wherein the determining whether the cell electrode is defective comprises:
applying a learning-based algorithm that automatically recognizes repetitive patterns or defects based on a comparison with past data.

11. The method of claim 1, further comprising:
storing the electrode image, the separator image, the composited cell electrode image, and a defect history and analysis results of the cell electrode obtained using the composited cell electrode image.

12. An apparatus for inspecting a cell electrode, comprising:
a first imager configured to acquire an electrode image;
a second imager configured to acquire a separator image;
an image processor configured to align the acquired electrode image and the acquired separator image, and composite the electrode image and the separator image to generate a cell electrode image;
an inspector configured to determine whether the cell electrode is defective using the composited cell electrode image; and
a controller configured to control the first imager, the second imager, the image processor, and the inspector.

13. The apparatus of claim 12, wherein the first imager comprises a light source using radiation, and the second imager comprises a light source having a wavelength region of any one of visible light, ultraviolet light, and infrared light.

14. The apparatus of claim 12, wherein the first imager and the second imager are each configured to acquire images from a plurality of angles while a cell is being rotated up to 360 degrees.

15. The apparatus of claim 12, wherein the controller comprises a reconstructor configured to reconstruct two-dimensional images of the electrode and the separator into three-dimensional images.

16. The apparatus of claim 12, wherein the image processor:
comprises an image processing algorithm, and
is configured to extract feature points of each image and align the images.

17. The apparatus of claim 12, wherein the inspector is configured to:
analyze a spacing between electrodes or a position of a separator end point using the composited cell electrode image; and
determine the cell electrode as defective if the spacing or the position deviates from a normal range.

18. The apparatus of claim 12, wherein the inspector is configured to evaluate a possibility of interference or a short circuit between the electrodes by analyzing an overlapping portion of the electrode image and the separator image using the composited cell electrode image.

19. The apparatus of claim 12, wherein the controller is configured to control an alignment corrector configured to fine-tune an imaging angle for alignment accuracy of the electrode image and the separator image.

20. The apparatus of claim 12, further comprising a storage configured to store the electrode image, the separator image, the composited cell electrode image, and a defect history and analysis results of the cell electrode obtained using the composited cell electrode image.
